(19) United States
(12) Patent Application Publication
(10) Pub. No.: US 2017/0318439 A1
(43) Pub. Date: Nov. 2, 2017

(54) MESSAGE DELIVERY RELIABILITY

(71) Applicant: Google Inc., Mountain View, CA (US)

(72) Inventors: Nagbhushan Veerapaneni, Saratoga, CA (US); Madhukar Narayan Thakur, San Jose, CA (US)

(73) Assignee: Google Inc., Mountain View, CA (US)

(21) Appl. No.: 15/653,418

(22) Filed: Jul. 18, 2017

Related U.S. Application Data
(63) Continuation of application No. 14/730,175, filed on Jun. 3, 2015.
(60) Provisional application No. 62/009,174, filed on Jun. 7, 2014.

(51) Int. Cl. H04W 4/14; H04W 12/06; H04L 29/06

(52) U.S. Cl. CPC H04W 4/14; H04L 63/08; H04W 12/06

(57) ABSTRACT

Systems, methods and computer readable media for computing message delivery reliability are disclosed. In some implementations, the method can include generating message delivery reliability information based on statistics of receiving one or more codes returned from one or more users. The method can also include routing a subsequent message based on the message delivery reliability information. The routing can include selecting an aggregator to deliver the subsequent message based on the message delivery reliability information. Generating message delivery reliability information can include receiving a contact identifier for a user device, and generating a code. The method can also include sending a message containing the code to the user device via an aggregator using the contact identifier. The method can further include receiving the code from the user device and generating statistics based on the sending and receiving of the code.

### RELATED APPLICATIONS

This application is a continuation of, and claims priority to, U.S. patent application Ser. No. 14/730,175, filed Jun. 3, 2015, which claims the benefit of U.S. Provisional Patent Application No. 62/009,174, filed on Jun. 7, 2014, which is incorporated herein by reference in its entirety.

### BACKGROUND

Messages, e.g., short message service (SMS) messages, are used frequently to exchange information with wireless devices. In addition to personal messaging between users, SMS messages may be used to deliver time- or mission-critical information e.g., banking and travel information. Reliable and timely delivery of SMS messages can be an important consideration.

SMS protocols may be open-loop and may not include a direct indication of whether (and when) a message was delivered. Messages may travel through numerous intermediaries (e.g., sending application, aggregator(s) or carrier), of which no one intermediary may have complete and accurate message delivery data.

### SUMMARY

Some implementations relate generally to messaging systems and, more particularly, to methods, systems and computer readable media for measuring message delivery reliability for messaging systems (e.g., SMS) and for dynamic routing of subsequent SMS messages based on the message delivery reliability information. Some implementations can include a method. In some implementations the method can include generating message delivery reliability information based on statistics of receiving one or more codes returned from one or more users. The method can also include routing a subsequent message based on the message delivery reliability information, wherein the routing includes selecting an aggregator to deliver the subsequent message based on the message delivery reliability information.

Generating message delivery reliability information can include receiving, at one or more processors, a contact identifier for a user device, and generating, at the one or more processors, a code. The method can also include sending, from the one or more processors, a message containing the code to the user device using the contact identifier. The method can further include receiving, at the one or more processors, the code from the user device.

The method can also include creating, at the one or more processors, a message delivery summary including one or more of message routing information (e.g., aggregator), geographic region the message was sent to, a time when the message was sent, and a completion time. The method can further include sending, from the one or more processors, the message delivery summary to the statistics system.

Some implementations can include a system comprising one or more processors configured to perform operations. The operations can include generating message delivery reliability information based on statistics of receiving one or more codes returned from one or more users. The operations can also include routing a subsequent message based on the message delivery reliability information, wherein the routing includes selecting an aggregator to deliver the subsequent message based on the message delivery reliability information.

Generating message delivery reliability information can include receiving a contact identifier for a user device and generating a code. The operations can also include sending a message containing the code to the user device using the contact identifier and receiving the code from the user device. The operations can further include creating a message delivery summary including one or more of routing information (e.g., aggregator), geographic region message was sent to, a time when the message was sent, and a completion time. The operations can also include sending the message delivery summary to the statistics system.

Some implementations can include a nontransitory computer readable medium having software instructions stored thereon that, when executed by one or more processors, causes the one or more processors to perform operations. The operations can include generating message delivery reliability information based on statistics of receiving one or more codes returned from one or more users. The operations can also include routing a subsequent message based on the message delivery reliability information, wherein the routing includes selecting an aggregator to deliver the subsequent message based on the message delivery reliability information.

Generating message delivery reliability information can include receiving a contact identifier for a user device and generating a code. The operations can also include sending a message containing the code to the user device using the contact identifier and receiving the code from the user device. The operations can further include creating a message delivery summary including one or more of routing information (e.g., aggregator), geographic region message was delivered to, a time when the message was sent, and a completion time. The operations can also include providing the message delivery summary (e.g., to a statistics system).

Some implementations can include a method. The method can include sending a query message to an application installed in a user device. The method can also include receiving the message and automatically responding with an acknowledgement message. The method can further include creating a message delivery summary including a route used to deliver the message, a geographic region associated with the user device, a time when the query message was sent, and a completion time when the acknowledgement message was received. The method can also include providing the message delivery summary (e.g., to a statistics system), and generating message delivery reliability information. The method can further include routing a subsequent message based on the message delivery reliability information.

Some implementations can include a system comprising one or more processors configured to perform operations. The operations can include sending a query message to an application installed in a user device. The operations can also include receiving the message and responding with an acknowledgement message. The operations can further include creating a message delivery summary including message routing information, geographic region the message was sent to, a time when the query message was sent, and a completion time when the acknowledgement message was received. The operations can also include providing the message delivery summary (e.g., to a statistics system), and generating message delivery reliability information.

Some implementations can include a nontransitory computer readable medium having software instructions stored thereon that, when executed by one or more processors, causes the one or more processors to perform operations. The operations can include sending a query message to an application installed in a user device. The operations can also include receiving the message and responding with an acknowledgement message. The operations can further include creating a message delivery summary including message routing information, geographic region the message was sent to, a time when the query message was sent, and a completion time when the acknowledgement message was received. The operations can also include providing the message delivery summary (e.g., to a statistics system), and generating message delivery reliability information.

In any of the implementations mentioned above (e.g., system, method or computer readable medium), the contact identifier can include a phone number and the message can include an SMS message. Also, in any of the implementations mentioned above, sending the message can include sending the message to an aggregator for delivery to the user device. Message routing information can include an aggregator identifier of the aggregator used for message delivery. Further, in any of the implementations mentioned above, the message delivery summary can further include a service identifier, a message identifier and an authentication identifier. The code can include one of an authentication code configured for authenticating a user seeking access to a website, a code for receiving an internet or online service, a code for gaining access to a consumable resource (e.g., higher CPU usage, greater bandwidth, more disk storage space or the like), a code for receiving an enhanced feature of a service, or a code for receiving an offer.

Some implementations, by including one or more of the above-mentioned features, can provide measurement of message (e.g., SMS message) delivery reliability. Measurement statistics can be updated periodically (e.g., hourly, daily, weekly or the like) to help ensure accuracy and provided in a relatively timely manner. Also, message delivery reliability data can help to decide which aggregator to use (e.g., based on aggregator completion rates), thus providing a dynamic routing system.

Some implementations can include a method comprising sending, from one or more processors, a message containing a code to a user device, and receiving, at the one or more processors, the code from the user device. The method can also include creating, at the one or more processors, a message delivery summary including one or more of message routing information, a time the message was sent and a time the code was received. The method can further include providing, from the one or more processors, the message delivery summary.

Some implementations can include a method comprising selecting, at one or more processors, a route for a message based on message delivery reliability information including statistics of receiving one or more codes returned from one or more users.

Some implementations can include a method comprising generating message delivery reliability information for a route based on statistics of receiving one or more codes returned from at least one user, wherein the codes are sent to at least one user via a first communication link including the route and returned via a second communication link different from the first communication link.

Some implementations can include a method comprising sending a deliverability measurement message to a user device, and receiving a response to the deliverability measurement message from the user device. The method can also include generating deliverability measurement message sending and receiving information. The method can further include selecting a route for a subsequent message based on deliverability information.

In some of the above implementations, the deliverability measurement message can be sent to an application in the user device. The response can be received from an application in the user device. The deliverability measurement message sending and receiving information can be provided to a statistics system. The deliverability information can be received from a statistics system. The deliverability information can be derived from the deliverability measurement message sending and receiving information.

Some implementations can include a system comprising one or more processors configured to perform operations. The operations can include sending, from the one or more processors, a message containing a code to a user device, and receiving, at the one or more processors, the code from the user device. The operations can also include creating, at the one or more processors, a message delivery summary including one or more of message routing information, a time the message was sent and a time the code was received. The operations can further include providing, from the one or more processors, the message delivery summary.

Some implementations can include a system comprising one or more processors configured to perform operations. The operations can include selecting, at the one or more processors, a route for a message based on message delivery reliability information including statistics of receiving one or more codes returned from one or more users.

Some implementations can include a system comprising one or more processors configured to perform operations. The operations can include generating message delivery reliability information for a route based on statistics of receiving one or more codes returned from at least one user, wherein the codes are sent to the at least one user via a first communication link including the route and returned via a second communication link different from the first communication link.

Some implementations can include a system comprising one or more processors configured to perform operations. The operations can include sending a deliverability measurement message to a user device, and receiving a response to the deliverability measurement message from the user device. The operations can also include generating deliverability measurement message sending and receiving information, and selecting a route for a subsequent message based on deliverability information.

In some of the above implementations, the deliverability measurement message can be sent to an application in the user device. The response can be received from an application in the user device. The deliverability measurement message sending and receiving information can be provided to a statistics system. The deliverability information can be received from a statistics system. The deliverability information can be derived from the deliverability measurement message sending and receiving information.

Some implementations can include a nontransitory computer readable medium having software instructions stored thereon that, when executed by one or more processors, causes the one or more processors to perform operations. The operations can include sending, from the one or more processors, a message containing a code to a user device, and receiving, at the one or more processors, the code from the user device. The operations can also include creating, at the one or more processors, a message delivery summary including one or more of message routing information, a time the message was sent and a time the code was received. The operations can further include providing, from the one or more processors, the message delivery summary.

Some implementations can include a nontransitory computer readable medium having software instructions stored thereon that, when executed by one or more processors, causes the one or more processors to perform operations. The operations can include selecting, at one or more processors, a route for a message based on message delivery reliability information including statistics of receiving one or more codes returned from one or more users.

Some implementations can include a nontransitory computer readable medium having software instructions stored thereon that, when executed by one or more processors, causes the one or more processors to perform operations. The operations can include generating message delivery reliability information for a route based on statistics of receiving one or more codes returned from at least one user, wherein the codes are sent to the at least one user via a first communication link including the route and returned via a second communication link different from the first communication link.

Some implementations can include a nontransitory computer readable medium having software instructions stored thereon that, when executed by one or more processors, causes the one or more processors to perform operations. The operations can include sending a deliverability measurement message to a user device, and receiving a response to the deliverability measurement message from the user device. The operations can also include generating deliverability measurement message sending and receiving information. The operations can further include selecting a route for a subsequent message based on deliverability information.

In some of the above implementations, the deliverability measurement message can be sent to an application in the user device. The response can be received from an application in the user device. The deliverability measurement message sending and receiving information can be provided to a statistics system. The deliverability information can be received from a statistics system. The deliverability information can be derived from the deliverability measurement message sending and receiving information.

Some implementations can include a system comprising one or more processors configured to perform operations. The operations can include generating, at a statistics system, message delivery reliability information based on statistics of receiving one or more codes returned from one or more users, and providing, from the statistics system, the message delivery reliability information.

Some implementations can include a nontransitory computer readable medium having software instructions stored thereon that, when executed by one or more processors, causes the one or more processors to perform operations. The operations can include generating, at a statistics system, message delivery reliability information based on statistics of receiving one or more codes returned from one or more users. The operations can also include providing, from the statistics system, the message delivery reliability information.

### BRIEF DESCRIPTION OF THE DRAWINGS

FIG. 1 is a diagram of an example message delivery reliability measurement system in accordance with some implementations.

FIG. 2 is a flow chart of an example method for message delivery reliability measurement in accordance with some implementations.

FIG. 3 is a diagram of an example message delivery reliability measurement system in accordance with some implementations.

FIG. 4 is a flow chart of an example method for message delivery reliability measurement in accordance with some implementations.

FIG. 5 is a diagram of a computer system for message delivery reliability measurement in accordance with some implementations.

### DETAILED DESCRIPTION

In general, some implementations provide systems, methods or computer readable media for message delivery reliability measurement.

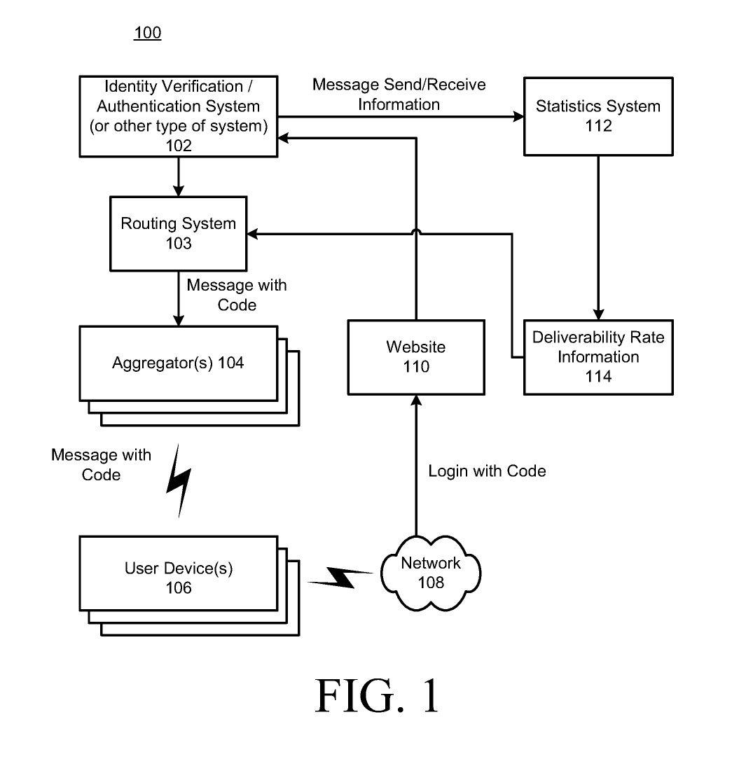

FIG. 1 is a diagram of an example message delivery reliability measurement system 100. The system 100 can include an identity verification/authentication system 102, a routing system 103, an aggregator 104, a network 108, a website 110, and a statistics system 112.

In operation, the identity verification/authentication system 102 can send a message (e.g., an SMS message) containing an identity verification code (or authentication code) to a user device 106 via an aggregator 104. The aggregator used for message delivery can be selected by the routing system 103 (e.g., from one or more aggregators available for the geographic region to which the message is being sent). Some implementations of a message delivery system may include a number of message routing choices prior to message delivery. Using an implementation of the message reliability measurement system discussed herein, the routing system 103 may be able to better determine which of the routing options (e.g., which aggregator) may be best suited for any given message based on deliverability rate information 114 discussed below. It will be appreciated that while one user device 106 is shown and discussed for illustration purposes, an actual implementation may be sending many messages to many user devices, with each message having its own code and being designated for a particular user device. The system 102 can store routing information for each message (e.g., the aggregator selected by the system). The routing system (103) (or other entity) may optionally provide routing information (e.g., aggregator) to the identity verification/authentication system 102. The routing information can include, for example, an identification of an aggregator used to deliver the message.

When the user device 106 receives the message containing the authentication/identity verification code (“the code”), a user can access the website 110 (or other web service) via the network 108 and enter the code to provide identity verification and or user authentication. Receiving the code from the website also serves to provide an indication that the user received the message with the code data intact (e.g., the SMS message was not garbled). Information about receiving the code can be sent to the identity verification/authentication system 102.

The identity verification/authentication system 102 can compile a message delivery summary that can include one or more of a message route (e.g., aggregator information), a geographic region the message was sent to, a time when the message with the code was sent, a time when the code was received from the user device, a service identifier (e.g., an identifier of the service making the authentication/identification request), a message or call identifier (e.g., an identifier used by the service making the request to identify the request), or an identifier of the type of authentication or identification being used. The message delivery summary can include data that has been treated such that the summary can be used to derive delivery reliability statistics of an aggregator, a geographic region or the like without including or relying on personally identifiable information of users.

The message delivery summary can be sent to the statistics system 112 for message delivery reliability measurement. For example, the statistics system can determine delivery reliability information based on the sent/received timestamps of messages or a ratio of completed/acknowledged messages to sent messages. The statistics system 112 can include a system configured to gather or aggregate message delivery information in a central location from one or more identity verification/authentication systems (or other systems). The statistics system 112 can also include a time series statistical engine (or specialized software package) configured to perform time series statistical analysis functions.

The statistical system 112 can be configured to periodically (or instantaneously) calculate message delivery reliability rates for messages to provide an indication of messages that were delivered. For example, data can be gathered over an interval (e.g., 5 minutes) and moving window sums can be generated over one or more intervals (e.g., one or more of 5 minutes, 30 minutes, 1 hour, 6 hours, 12 hours, 1 day, 7 days). Message delivery statistics can be calculated on a recurring interval e.g., every 5 minutes. Other calculation intervals can be used. The message delivery reliability rates statistics can be segmented according to one or more of an aggregator, carrier, geographic area, language or any other suitable variable. In general, message delivery reliability can be calculated as: number of messages acknowledged/number of messages sent. Messages acknowledged can include those messages for which a valid authentication/identity verification code was received. It will be appreciated that some implementations can include variations of the basic formula mentioned above. A statistically significant number of message data may need to be processed in order to arrive at meaningful, valid statistics for any given variable. In addition to message delivery reliability, the statistics system can be configured to compute message delay/latency using timestamps of sent/received codes. For example, an “end to end” delay can be determined based on a difference between send timestamps and receive timestamps of corresponding messages, which, in some instances, may include a manual delay based on the amount of time a user takes to see and enter the received code. Some users may enter the verification code promptly and statistics can be computed to determine the difference. Some implementations can include an “auto-pickup” phone (or mobile device) application configured to automatically detect a received code and to respond without user involvement or input, thus there would be no manual delay in such implementations. However, mobile application coverage may be sparse in some areas. In countries/routes with enough “auto pickup” volume, a system can statistically compare the manual vs. auto round trip delay and compute a difference function for the manual/human delay. The system can then use the human delay function on other routes (assuming that human behavior for a give usage would be similar worldwide).

The disclosed system, method and computer readable media can offer an improvement over existing ways to determine message delivery. For example, some telecom aggregators may provide delivery reports, which can include batched (or grouped) reports of the outcome of an attempt to delivery one or more SMS messages. There may not be a generally accepted standard for such reports and the content and format may vary from aggregator to aggregator. The delivery reports may suffer from two deficiencies: 1) the delivery reports may be inaccurate, and 2) the delivery reports are batched and may not provide timely feedback. An example of a possible inaccuracy includes inaccurate delivery confirmation (e.g., an aggregator may indicate delivery, where the delivery is only based on delivery to a carrier and not to the end user, who did not receive the message).

As described below, the disclosed method of message delivery reliability measurement can use an existing data flow or action sequence (e.g., identity verification) to measure message delivery reliability. Thus, message delivery reliability can be measured without any additional burden on users and without having to rely on possibly untimely or inaccurate reports from telecom aggregators or carriers. Further, as described above, message delivery latency/delay can be computed based on message send/receive timestamps. For example, a message code (e.g., a code sent via SMS) can be received at an authentication system front end and can then be passed to the messaging system. The messaging system can compute a round trip latency or delay by comparing a timestamp captured when the message was sent with a timestamp captured when the code was received. Sometimes, a user may not receive a code initially and may request a code be sent again one or more subsequent times. The system may try to resend the code one or more subsequent times. Once the code is received, the system may attribute the sent time with the most recent time the user requested the code.

In some implementations, the computed delivery reliability statistics computed can be used to change the routing amongst various possible routes (e.g., aggregators). For example, the statistics system (112) can be configured to compute the delivery reliability e.g., deliverability rate information (114) for multiple routes to the same or nearby destinations. The deliverability rate information 114 can be supplied to the routing system 103 so that the routing system 103 can determine or select routings options (e.g., aggregator) for message delivery based on the deliverability rate information 114. For example, if a message delivery system (e.g., 102 or 302) is sending 100 SMS messages to a phone number in another country over a short period of time, the system may send some large percentage (e.g., 80%) over the most reliable aggregator connection, but may send a small percentage through other aggregator connections as well. The statistics system 112 can then compute the reliability of each aggregator for SMS to the other country. When the best aggregator drops in reliability, the system can dynamically, without human intervention, send SMS messages to the other country via other routes (e.g., other aggregators). The reliability of a route can be measured for each country or for smaller units, e.g., city codes, or end-user carrier, or the like. Thus, some implementations can provide an ability to compute reliability of end user phones, countries, carriers, cities or the like, and can adaptively change routing for future SMS messages in response to an outage.

In some implementations, the verification/authentication system 102 can include a two-factor authentication for logins (e.g., where the user's phone is sent a code and he/she has to enter it back in the login screen to be able to login). Also, it will be appreciated that verification/authentication system 102 need not be an identity verification system. Any system in which a user has an incentive to respond by sending a code back can be used as verification/authentication system 102. Also, any system in which the user is being provided some online service (e.g., email account, messaging account, social network account, or the like), an offer or one or more enhanced features of a service (identity verification is just one example of a feature of a service) can be used as verification/authentication system 102. For example, the user can get 100 GB of extra disk space for returning the SMS code as described herein (e.g., an enhanced feature). In another example, an application may give the user a $5 coupon (i.e., an offer) or provide him the ability to send more than x email messages per day (i.e. an enhanced feature), or the like upon SMS code verification as described herein. In general, any service in which the user seeks a feature or service, and the web application can then ask for an SMS code check before providing the feature/service being sought can be used.

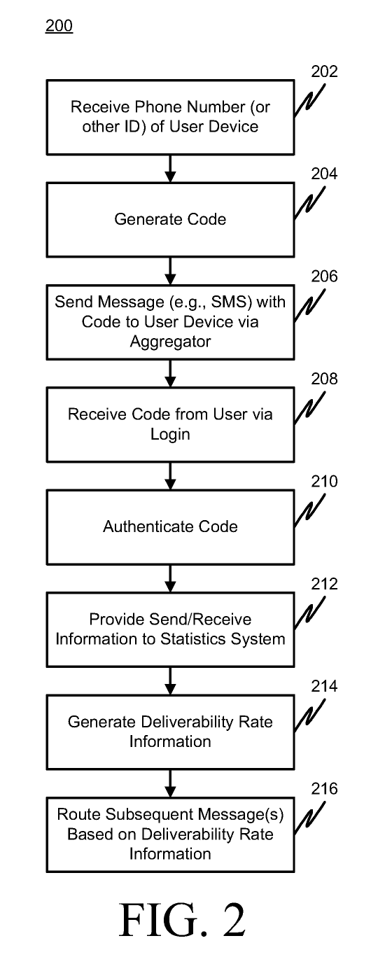

FIG. 2 is a flow chart of an example method 200 for message delivery reliability measurement in accordance with some implementations. Processing begins at 202, where a phone number (or other identifier) of a user device is received. Processing continues to 204.

At 204, a code is generated. For example, the code can be an identification verification code, an authentication code or the like. The code can be generated using a random number generator, other suitable number generator, or the like. Processing continues to 206.

At 206, a message including the code is sent to the user device. For example, an SMS message including the code is sent. The message may be sent via one telecommunication aggregator and a telecommunication carrier. Processing continues to 208.

At 208, the code is received from the user device. For example, the user can enter the code as part of a login, authentication or identity verification process, via the user device or from a computer (e.g., desktop, laptop or tablet) accessing a page of a website (or other web service). In other implementations, the code could be provided for accessing any service on the internet or to get additional resources or privileges of some kind from an online application/service. In general, the code can be for any purpose for which the user has an incentive to provide the code received via SMS to the system. Processing continues to 210.

At 210, the code is optionally sent to a system (e.g., an authentication/identity verification system) for verification. The verified code and receipt information can be stored. Processing continues to 212.

At 212, send/receive information for the message is provided to a statistics system. For example, a message delivery summary (or digest) report can be generated and sent to a statistics system. The message summary report can include one or more of, routing information (e.g., aggregator), geographic region the message was sent to, a time when the message with the code was sent, a time when the code was received from the user device, a service identifier (e.g., an identifier of the service making the authentication/identification request), a message or call identifier (e.g., an identifier used by the service making the request to identify the request), or an identifier of the type of authentication or identification being used. In addition to send/receive information for completed messages, information about messages that were sent, but for which no code was received can also be provided to the statistics system. Processing continues to 214.

At 214, message delivery reliability rate information can be generated. In some implementations, the statistics system can collect and combine (or aggregate) the message delivery information from multiple computer systems (e.g., systems in a distributed or cloud-based architecture). The message delivery reliability rate information generated by the statistics system can be based on message delivery information received from the multiple computer systems (e.g., multiple authentication/identity verification systems). For example, the statistics system can compute message delivery reliability statistical measures using the send/receive information from step 212, described above. The deliverability rate information can be computed using a formula similar to that described above in connection with FIG. 1. Processing continues to 216.

At 216, subsequent messages are routed based on deliverability rate information. As discussed above, the computed delivery reliability statistics computed can be used to change the routing amongst various possible routes (e.g., aggregators). For example, the statistics system (112) can be configured to compute the delivery reliability information (114) for multiple routes to the same or nearby destinations. The delivery reliability information 114 can then be used by a routing system (e.g., 103 or 303). In another example, if a message delivery system (e.g., 102 or 302) is sending 100 SMS messages to phones numbers in another country over a short period of time, the system may send some large percentage (e.g., 80%) over the most reliable aggregator connection, but may send a small percentage through other aggregators as well. When the best (e.g., currently most reliable) aggregator drops in reliability, the system can dynamically, without human intervention, send subsequent SMS messages to phones in the other country via other routes (e.g., other aggregators). Thus, some implementations can provide an ability to compute reliability of aggregators, end user phones, countries, carriers, cities or the like, and can adaptively change routing for future SMS messages in response to reliability statistics.

It will be appreciated that 202-216 can be repeated in whole or in part in order to accomplish a contemplated message delivery reliability measurement task.

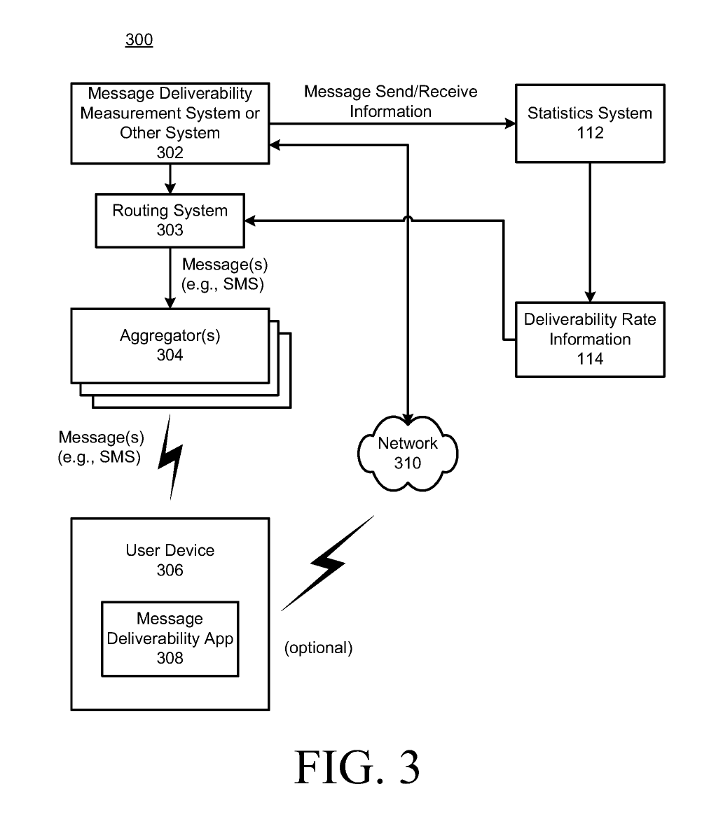

FIG. 3 is a diagram of an example message delivery reliability measurement system 300 in accordance with some implementations. The system 300 includes a message deliverability measurement system 302, one or more aggregator(s) or carrier(s) 304, an optional network 310, and a statistics system 112.

In operation, one or more users can install a message deliverability application 308 on a user device 306 (e.g., wireless mobile device). The message deliverability measurement system 302 (e.g., SMS message deliverability measurement system) sends an SMS message to the user device 306. The SMS message can be received by the message deliverability application 308.

The message deliverability application 308 can send a response message to the message deliverability measurement system 302. The response message can be a message type e.g., an HTTP message or the like sent via network 310.

The message deliverability measurement system 302 can collect one or more response messages and generate message delivery send/receive information digests, which are sent to the statistics system 112. The statistics system 112 can generate message deliverability rate information 114 and supply the deliverability rate information 114 to a message routing system 303 as described above with respect to 103 of FIG. 1.

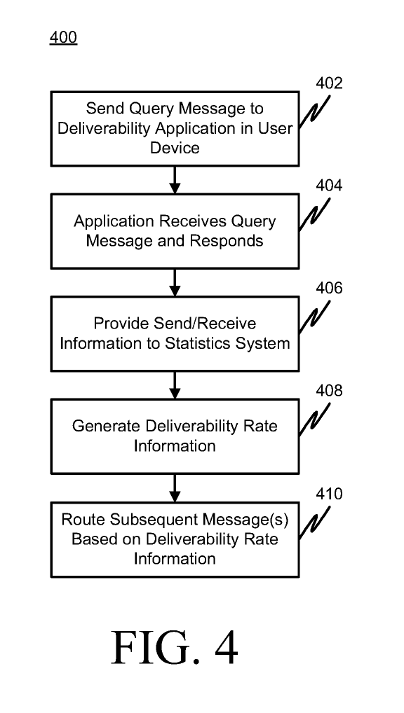

FIG. 4 is a flow chart of an example method 400 for message delivery reliability measurement in accordance with some implementations. Processing begins at 402, where a query (or probe) deliverability measurement message is sent to a user device having a message deliverability application installed (e.g., to user device 306 having application 308 installed). Processing continues to 404.

At 404, the query message is received by a message deliverability application, and the message deliverability application sends a response (or acknowledgement) message. For example, a response message may be sent on a data channel to a message deliverability measurement system server. Processing continues to 406.

At 406, message send/receive information is provided to a statistics system. The message send/receive information can be based on query message send information (e.g., time sent, aggregator, carrier, geographic region, language or the like) and response message information (e.g., time received). Processing continues to 408.

At 408, message delivery reliability information is generated. For example, a statistics system can generate message delivery reliability statistics based on send/receive information similar to that described above in connection with FIGS. 1 and 2. Processing continues to 410.

At 410, subsequent messages are routed based on deliverability rate information (e.g., by a routing system 103 or 303). As discussed above, the computed delivery reliability statistics computed can be used to dynamically change the routing amongst various possible routes (e.g., aggregators).

For example, a user can install a message delivery reliability measurement application in the user's mobile phone. The message delivery reliability measurement application may be included as part of another application that may have other features desirable to the user to motivate the user to install the application. Alternatively, the message delivery reliability measurement application may include other functionality beyond message delivery reliability measurement. The message delivery reliability measurement application may request the user's permission before messages are sent from the server to the user device or responded to by the application.

Once installed, the message delivery reliability measurement application can register with a message delivery reliability measurement server and begin to receive (and acknowledge) query/probe messages. The number and frequency of messages may be limited by the user so as to avoid any possible excess message charges. Also, the application can provide the user with the option of temporarily suspending message delivery reliability measurement messages from being sent from the server, received by the user device or responded to by the application. The information received at the server from the message delivery reliability measurement application can be used as described above to determine message delivery reliability.

It will be appreciated that 402-410 can be repeated in whole or in part in order to accomplish a contemplated message delivery reliability measurement task.

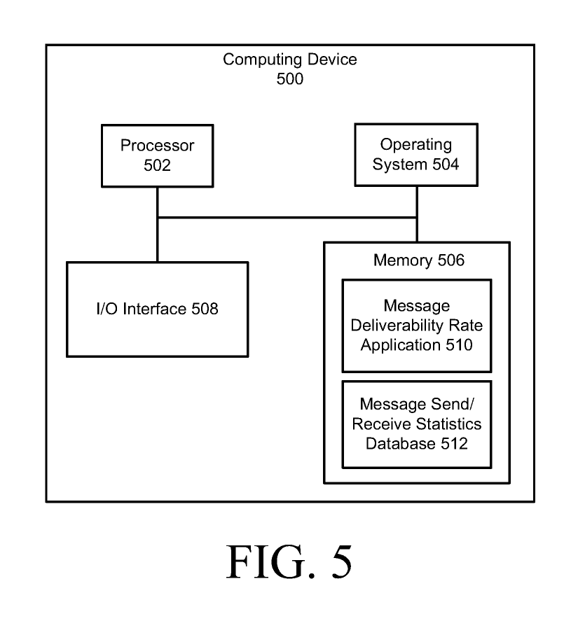

FIG. 5 is a diagram of an example computing device 500 that can be configured for message delivery reliability measurement in accordance with some implementations. The computing device 500 includes a processor 502, an operating system 504, a memory 506 and an I/O interface 508. The memory 506 can include a message delivery reliability measurement application 510 and a database 512 (e.g., for storing message delivery reliability statistics, send/receive information or the like).

In operation, the processor 502 may execute the message delivery reliability measurement application 510 stored in the memory 506. The message delivery reliability measurement application 510 can include software instructions that, when executed by the processor, cause the processor to perform operations for message delivery reliability measurement in accordance with the present disclosure (e.g., the message delivery reliability measurement application 510 can include one or more of steps 202-214 or 402-408 described above and, in conjunction, can access the database 512). The message delivery reliability measurement application 510 can also operate in conjunction with the operating system 504.

The message delivery reliability measurement computing device (e.g., 500) can include, but is not limited to, a single processor system, a multi-processor system (co-located or distributed), a cloud computing system, or a combination of the above.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle or the like. Also, client/user devices can include wearable computing devices (e.g., glasses, watches or the like), furniture mounted computing devices or building mounted computing devices.

All or a portion of a message delivery reliability measurement operation can be performed on a server system. For example, a user device can include a wireless mobile device and can be configured to send and receive messages via a server or other external system. The server can be configured to perform one or more of steps 202-214 or 402-408, with the user interface being displayed on the user device. The message delivery reliability information may be stored on a server, a cloud storage system, locally on a user device or on a combination of the above.

The user devices can be connected to the server via a network. The network connecting user devices to the server can be a wired or wireless network, and can include, but is not limited to, a WiFi network, a local area network, a wide area network, the Internet, or a combination of the above.

The data storage, memory or computer readable medium can be a nontransitory medium e.g., a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system or a cloud computing system).

Some implementations of the disclosed method, system, and computer readable media can be implemented in software (e.g., as a computer program product or nontransitory computer readable media having stored instructions for media presentation creation by imitation as described herein). The stored software instructions can be executed on a programmed general purpose computer, a special purpose computer, a microprocessor, or the like.

In some implementations, a mode of messaging can be chosen in which a user may be highly motivated to respond with the code (e.g., where the entering of the code sent in the message is part of another authentication or identity verification process that the user is motivated to complete, or other feature/service the user is seeking as discussed above in relation to 102 of FIG. 1). Otherwise, for example, it may be difficult to determine if a code response was not received due to user apathy or SMS delivery failure.

It is, therefore, apparent that there is provided, in accordance with the various example implementations disclosed herein, systems, methods and computer readable media for message delivery reliability measurement and message routing.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A system comprising:
one or more hardware processors configured to perform operations,
wherein the operations include:
sending a deliverability measurement message to a user device via a route, wherein the route includes a selected message aggregator selected from a plurality of message aggregators;
receiving a response to the deliverability measurement message from the user device;
generating message delivery information based on sending the deliverability measurement message and receiving the response;
measuring message delivery reliability based on the message delivery information, wherein the message delivery reliability includes route reliability having an indication of reliability of the selected message aggregator; and
selecting a subsequent route, including one of the plurality of message aggregators, for delivery of a subsequent message based on the route reliability.

2. The system of claim 1, wherein measuring message delivery reliability includes:
determining delivery reliability information based on a ratio of a number of completed messages to a number of sent messages.

3. The system of claim 2, wherein the deliverability measurement message includes a verification code.

4. The system of claim 3, wherein the number of completed messages includes messages for which a valid received verification code was received in the response, wherein a valid received verification code is one which matches the verification code sent in the deliverability measurement message corresponding to the response.

5. The system of claim 1, wherein the deliverability measurement message is configured to be read by an application that executes on the user device, such that the application can generate the response based on the deliverability measurement message.

6. The system of claim 1, wherein the operations further include:
providing the message delivery information to a statistics system, and
performing the measuring at the statistics system by periodically computing message delivery reliability for each of the plurality of message aggregators for which message delivery information is available.

7. The system of claim 1, wherein sending the deliverability measurement message and receiving the response is a message form a portion of an identity verification action sequence, and wherein messages sent and received in the identity verification action sequence are used to measure message delivery reliability.

8. A computer-implemented method comprising:
sending a deliverability measurement message to a user device via a route, wherein the route includes a selected message aggregator selected from a plurality of message aggregators;
receiving a response to the deliverability measurement message from the user device;
generating message delivery information based on sending the deliverability measurement message and receiving the response;
measuring message delivery reliability based on the message delivery information including a ratio of a number of completed messages to a number of sent messages, wherein the message delivery reliability includes route reliability having an indication of reliability of the selected message aggregator; and
selecting a subsequent route, including one of the plurality of message aggregators, for delivery of a subsequent message based on the route reliability.

9. The method of claim 8, wherein the deliverability measurement message includes a verification code.

10. The method of claim 9, wherein the number of completed messages includes messages for which a valid received verification code was received in the response, and wherein a valid received verification code is one which matches the verification code sent in the deliverability measurement message corresponding to the response.

11. The method of claim 8, wherein the deliverability measurement message is configured to be read by an application that executes on the user device, such that the application can generate the response based on the deliverability measurement message.

12. The method of claim 8, further comprising:
providing the message delivery information to a statistics system, and
performing the measuring at the statistics system by periodically computing message delivery reliability for each of the plurality of message aggregators for which message delivery information is available.

13. The method of claim 8, wherein sending the deliverability measurement message and receiving the response is a message form a portion of an identity verification action sequence, and wherein messages sent and received in the identity verification action sequence are used to measure message delivery reliability.

14. A nontransitory computer readable medium having stored thereon software instructions that, when executed by one or more processors, cause the one or more processors to perform operations including:
sending a deliverability measurement message to a user device via a route, wherein the route includes a selected message aggregator selected from a plurality of message aggregators, and wherein the deliverability measurement message includes a verification code;
receiving a response to the deliverability measurement message from the user device, wherein sending the deliverability measurement message and receiving the response form a portion of an identity verification action sequence, and wherein messages sent and received in the identity verification action sequence are used to measure message delivery reliability;
generating message delivery information based on sending the deliverability measurement message and receiving the response;
measuring message delivery reliability based on the message delivery information including a ratio of a number of completed messages to a number of sent messages, wherein the message delivery reliability includes route reliability having an indication of reliability of the selected message aggregator; and
selecting a subsequent route, including one of the plurality of message aggregators, for delivery of a subsequent message based on the route reliability.

15. The nontransitory computer readable medium of claim 14, the number of completed messages includes messages for which a valid received verification code was received in the response, and wherein a valid received verification code is one which matches the verification code sent in the deliverability measurement message corresponding to the response.

16. The nontransitory computer readable medium of claim 14, wherein the deliverability measurement message is configured to be read by an application that executes on the user device, such that the application can generate the response based on the deliverability measurement message.

17. The nontransitory computer readable medium of claim 14, wherein the operations further include providing the message delivery information to a statistics system.

18. The nontransitory computer readable medium of claim 17, wherein the operations further include performing the measuring at the statistics system by periodically computing message delivery reliability for each of the plurality of message aggregators for which message delivery information is available.

19. The nontransitory computer readable medium of claim 18, wherein the statistics system is configured to compute message delivery reliability for a plurality of routes to a same or nearby destination, wherein each route includes one of the plurality of message aggregators.

20. The nontransitory computer readable medium of claim 19, wherein the operations further comprise supplying measured message delivery reliability information to a routing system configured to determine routing options for message delivery based on the route reliability.
